(19) United States
(12) Patent Application Publication
(10) Pub. No.: US 2024/0086267 A1
(43) Pub. Date: Mar. 14, 2024

(54) SYSTEM AND METHOD FOR DETECTING ANOMALIES IN A CYBER-PHYSICAL SYSTEM

(71) Applicant: AO Kaspersky Lab, Moscow (RU)

(72) Inventors: Andrey B Lavrentyev, Moscow (RU); Artem M Vorontsov, Moscow (RU); Artyom M Nechiporuk, Moscow (RU); Vyacheslav I Shkulev, Moscow (RU); Alexander V Travov, Moscow (RU); Dmitry A. Ivanov, Moscow (RU); Nikolay N. Demidov, Moscow (RU); Maxim A Mamaev, Moscow (RU)

(21) Appl. No.: 18/351,811

(22) Filed: Jul. 13, 2023

(30) Foreign Application Priority Data
Sep. 9, 2022 (RU) 2022123995

(51) Int. Cl. G06F 11/07

(52) U.S. Cl. CPC G06F 11/0751

(57) ABSTRACT

Disclosed herein are systems and methods for detecting anomalies in a cyber-physical system. In one aspect, an exemplary method comprises, for a list of parameters of the CPS, collecting data containing values of the parameters of the CPS, generating at least two subsets of parameters of the CPS from the collected data, selecting at least two anomaly detectors from a list of anomaly detectors and selecting at least one corresponding subset of the parameters of the CPS for each selected anomaly detector, pre-processing each subset of the parameters of the CPS and transmitting an output of the pre-processing to the corresponding anomaly detector, for each pre-processed subset, detecting anomalies in the data using the corresponding respective anomaly detector, and detecting a combined anomaly in the CPS by combining and processing results obtained from the selected at least two anomaly detectors.

### CROSS REFERENCE TO RELATED APPLICATIONS

The present application claims priority to Russian Patent Application No. 2022123995, filed on Sep. 9, 2022, the entire content of which is incorporated herein by reference.

### FIELD OF TECHNOLOGY

The present disclosure relates to the field of industrial safety, and more specifically to systems and methods for detecting anomalies in a cyber-physical system.

### BACKGROUND

One of the urgent problems of industrial safety is the problem of safe operation of technological processes (TPs). The main threats to TPs include wear and tear and failure of equipment or assembly, unintentional errors or malicious actions in operational management, computer attacks on control systems and Information System (IS) and others.

To counter these threats, security systems of a cyber-physical systems (CPS) are traditionally used, which include Safety Instrumented Systems (SIS), anomaly detection systems based on an automated process control system (APCS) and specially built “external” monitoring systems for a particular equipment or assembly. The “external” systems are usually not integrated with the APCS. It should be noted that the above “external” systems, due to certain features of the CPS and TP, cannot always be deployed. However, even if such an installation is possible, the deployment of external systems is carried out only on critical units and assemblies of the enterprise due to the high cost and complexity in maintaining such external systems.

Unlike “external” systems, the SIS system, is built during the design of the enterprise. Then, the SIS system is integrated with the APCS system and serves to prevent the development of pre-known emergency processes. The obvious advantage of the SIS system is its simplicity, focus on the production processes of a particular enterprise, and taking into account all structural and technological solutions used at this enterprise. The disadvantages of the SIS system include the sufficient inertia of decision-making in the system and the presence of human factors in making such decisions. In addition, the SIS operates under the assumption of correct functioning of Control and Measuring Devices (CMD). In practice, ensuring a full implementation of a trouble-free operation of the CMD is not possible. For example, the CMD may periodically fail or may have the tendency to temporarily fail. In addition, duplication of all CMDs is extremely costly and not always technically possible or feasible.

However, anomaly detection systems based on APCS telemetry have the ability to simultaneously monitor all the TP of the enterprise, the interaction of various TP of the enterprise with each other. Due to the completeness of the data based on APCS telemetry, even in the presence of failures of the CMD, this approach allows the anomaly detection system to confidently detect anomalies that are deviations in the behavior of the monitored object—i.e., the CPS or IS. The wealth of data presented in the APCS allows monitoring with several models of the entire enterprise—both the physical (chemical or otherwise) processes of the enterprise, and the correct operation of all control systems for these processes, including the correctness of the actions of production operators.

In one example, the data associated with the monitoring includes:
telemetry of physical and chemical processes, such as sensor readings, setting values, control layers;
events in the CPS or IS (hereinafter referred to as events), such as individual commands, personnel actions, alarms, and other changes in the state of the monitored object.

Machine learning methods can be used to identify anomalies in telemetry data. The machine learning methods can be used to build highly efficient statistical models of the correct operation of the enterprise. For example, the efficient statistical model may be built with a large number of analyzed parameters. This allows users to find minor deviations in the operation of the equipment, even at an early stage of an anomaly development. The special architecture and interface of such systems allows these systems to work in parallel with the APCS system, without using its resources, to perform fault (i.e., anomaly) detection, display and isolation, as well as inform production operators about the detected anomalies and indicating certain technological parameters by which this anomaly was identified.

Using a variety of anomaly detection methods allows the detection to cover the entire range of deviations in the TP; however, the use of the same or intersecting data sets by several and anomaly detection models simultaneously leads to a need to combine information about the anomalies found (i.e., data fusion) by various methods and to provide CPS operators with a comprehensive summary information about the presence of an anomaly and characteristics of the anomaly.

An example of this approach is the in-line diagnostics of main oil pipelines using non-destructive testing methods. A combined in-line flaw detector, as a rule, consists of several separate diagnostic modules including ultrasonic thickness gauge (UTG), magnetic control module(s) (MCM), ultrasonic detector of parallel cracks and cracks of capacitor discharge (CD) welds and others. The run of the combined flaw detector through an industrial oil pipeline or product pipeline is carried out by sequentially connecting all its components into a single projectile with its subsequent movement in the flow of the pumping product. Thus, the entire diagnosed pipeline system will be uniformly covered with data from several types of control, which are further sent to the modules for automatic determination of the technological parameters of the pipeline and defects of its wall. Detection modules (detectors) of the above defects (i.e., anomalies) differ depending on the physical principles of control so that as a result, each of the modules produces its own set of defects and their characteristics. It is quite obvious that some of the types of defects will be observed and found by several of the modules in question. Therefore, it is quite natural to encounter the task of combining information from different modules into the concept of a single defect (combined anomaly). In addition, as a result of such a combination, it is possible to recalculate and clarify the essential characteristics of the defect, such as its type and dimensions, which would not be possible if only one type of control was present.

Therefore, there is a need for a more optimal way for detecting anomalies in a cyber-physical system, wherein the system operates with several anomaly detection modules such that a combined anomaly can be detected for the object, e.g., the CPS or IS, with subsequent unification (assembly) of information received from each of the modules into the combined anomaly.

### SUMMARY

Aspects of the disclosure relate to detecting anomalies in a cyber-physical system, by operating several anomaly detection modules and subsequently combining the information received from each of the modules.

In one exemplary aspect, a method is provided for detecting anomalies in a cyber-physical system, the method comprising: for a list of parameters of the CPS, collecting data containing values of the parameters of the CPS; generating at least two subsets of parameters of the CPS from the collected data; selecting at least two anomaly detectors from a list of anomaly detectors and selecting at least one corresponding subset of the parameters of the CPS for each selected anomaly detector; pre-processing each subset of the parameters of the CPS and transmitting an output of the pre-processing to the corresponding anomaly detector; for each pre-processed subset, detecting anomalies in the data using the corresponding respective anomaly detector; and detecting a combined anomaly in the CPS by combining and processing results obtained from the selected at least two anomaly detectors.

In one aspect, the method further comprises post-processing the detected anomalies from each selected anomaly detector; and combining the post-processed detected anomalies.

In one aspect, the selecting of the at least two anomaly detectors and the at least one corresponding subset of the parameters of the CPS for each selected anomaly detector is performed based on at least one of: characteristics of the CPS; a list of parameters of the CPS and their values from a subset of parameters of the CPS; and types of the collected data and an amount of the collected data.

In one aspect, the selecting of the at least two anomaly detectors and the at least one corresponding subset of the parameters of the CPS for each selected anomaly detector is performed based on at least one of: a quality metric; Receiver Operating Characteristics (ROC) curve analysis results; execution time; and an amount of resources used by a computer performing the anomaly detection.

In one aspect, the pre-processing of a subset of the parameters of the CPS includes at least of one: data buffering with a time buffer of a pre-determined length; filtering of invalid data or data that arrived with a delay greater than a pre-determined length of time; reordering based on time points of obtaining the values of parameters of the CPS; filling in gaps in the values of parameters of the CPS; interpolation to a uniform grid; normalization of values of the parameter of the CPS; and repackaging the values parameters of the CPS for processing by the anomaly detector.

In one aspect, a detector of the at least two anomaly detectors detects anomalies by at least one of: detecting anomalies when a forecast error exceeds a pre-determined threshold value, wherein the forecast error is computed by predicting values of the parameters of the CPS and then determines a total forecast error for the values of the parameters of the CPS; detecting anomalies by applying a machine learning model based on the values of the parameters of the CPS; detecting anomalies when a rule for detecting anomalies is applied; and detecting anomalies by comparing the values of the parameters of the CPS with limit values of ranges of values established for the respective parameters.

In one aspect, a value of at least one of the parameters of the CPS comprises at least one of: a sensor measurement; a value of a controlled parameter of an actuator; a setpoint of an executive mechanism; a value of at least one input signal of a proportional-integral-differentiating (PID) regulator; and a value of an output signal of the PID controller.

In one aspect, values of the parameters of the CPS are collected from the CPS at a same time interval with an indication of the parameters of the CPS or from indication parts of the CPS in a form of a plurality of separate fluxes of values of the parameters of the CPS indicating the parameters contained in each stream.

In one aspect, result obtained from the selected at least two anomaly detectors are combined in at least one of the following ways: by combining anomaly localization regions from individual anomaly detectors such as common anomalies are localized, wherein said regions determine anomalies in space and/or time; by analyzing contributions of each detector to the combined anomaly; and by calculating predetermined characteristics of the combined anomaly using characteristics of the anomalies obtained from each of the detectors and information about respective contributions to the combined anomaly.

In one aspect, the combining of the anomaly localization regions is performed by: determining when a spatial or temporal region exceeds a predetermined percentage of the combined area; determining when centers of anomaly localization regions lie in a certain spatial or temporal region; and determining when a trained neural network identified the region as a region that belongs to a combined anomaly.

In one aspect, a contribution of a particular anomaly detector to the combined anomaly is determined by setting a feature vector corresponding to the total number of anomaly detectors, and by performing at least one of the following actions: equating the contribution of the particular anomaly to the combined anomaly to a number calculated from the contribution of the spatial or temporal region of the anomaly obtained by the particular detector to the combined anomaly; determining the contribution of the particular anomaly by a degree of proximity to the center of the combined anomaly; determining the contribution of the particular anomaly by applying a pretrained neural network that evaluates contributions; when a combined anomaly of the particular detector is not present in the formation, setting the contribution to zero; and when there is information about a degree of reliability or criticality of a particular detector for a technological process (TP) of the CPS in which the said detector detects an anomaly, changing the contribution of the detector based on the information about the degree of reliability or criticality.

In one aspect, after identifying at least one anomaly by each selected anomaly detector, the output data is further post-processed, wherein the post-processing includes: calculating an extended set of anomaly characteristics, including anomaly hazard assessment, determining types and sizes of the anomalies, normalizing and unifying the output information about anomalies, and detecting the combined anomaly by combining results obtained from the selected detectors.

In one aspect, when calculating the characteristics of the anomalies is not feasible or possible, setting a pre-determined value for the characteristics of the anomaly for which the calculation is not performed.

In one aspect, at least one of the following characteristics of the anomaly associated with the detector that detected the anomaly is calculated: a hazard class of the anomaly, the type and size of the anomaly; a probability of anomaly detection by the anomaly detector; values of deviations of the predicted values of the parameters of the CPS from true values or default values, the values of the specified deviations from settings, root mean square values of the measures of deviations of at least some of the parameters of the CPS used in the anomaly detector; maximum or average values of deviations of observed values of parameters of the CPS from certain predetermined limits, durations in time and frequency of specified deviations; and detector performance in detecting anomalies.

In one aspect, the anomaly detector is selected for a particular subset of the parameters of the CPS, such that: the selected anomaly detector provides a predetermined accuracy and completeness in anomaly detection for the particular subset, in accordance with a predetermined performance of the anomaly detector on the particular subset of parameters of the CPS, or in accordance with expert knowledge about the subset of parameters of the CPS.

In one aspect, subsets of parameters of the CPS are selected in accordance with at least one of the following characteristics of the subsets: significances of the parameters of the CPS for a technological process; the parameters of the CPS being associated with a particular type of equipment; the parameters of the CPS belonging to one technological process; and based on uniformity of physical parameters of the CPS in a subset.

According to one aspect of the disclosure, a system is provided for detecting anomalies in a cyber-physical system, the system comprising a hardware processor configured to: for a list of parameters of the CPS, collect data containing values of the parameters of the CPS; generate at least two subsets of parameters of the CPS from the collected data; select at least two anomaly detectors from a list of anomaly detectors, select at least one corresponding subset of the parameters of the CPS for each selected anomaly detector; pre-process each subset of the parameters of the CPS and transmitting an output of the pre-processing to the corresponding anomaly detector; for each pre-processed subset, detect anomalies in the data using the corresponding respective anomaly detector; and detect a combined anomaly in the CPS by combining and processing results obtained from the selected at least two anomaly detectors.

In one aspect, the system further comprises: at least one post-processing unit designed to process the output of a corresponding anomaly detector before transmitting the output to the ensemble tool, each detector having a dedicated set of post-processing units.

In one aspect, the post-processing units perform at least one of the following steps: assessment of risks of anomalies, determining types and sizes of anomalies, and normalizing and unification of output information about anomalies.

In one exemplary aspect, a non-transitory computer-readable medium is provided storing a set of instructions thereon for detecting anomalies in a cyber-physical system, wherein the set of instructions comprises instructions for: for a list of parameters of the CPS, collecting data containing values of the parameters of the CPS; generating at least two subsets of parameters of the CPS from the collected data; selecting at least two anomaly detectors from a list of anomaly detectors and selecting at least one corresponding subset of the parameters of the CPS for each selected anomaly detector; pre-processing each subset of the parameters of the CPS and transmitting an output of the pre-processing to the corresponding anomaly detector; for each pre-processed subset, detecting anomalies in the data using the corresponding respective anomaly detector; and detecting a combined anomaly in the CPS by combining and processing results obtained from the selected at least two anomaly detectors.

The method and system of the present disclosure are designed to provide improvements in detecting anomalies in a cyber-physical system. The first technical effect is to enable scaling of the system for detecting anomalies in the CPS by using a variety of anomaly detectors in the CPS or IS and assembling the results of these detectors to detect anomalies in the CPS or IS. The second technical effect is improving the accuracy of the anomaly detection through the use of multiple anomaly detectors in the CPS or IS and the subsequent unification of the results of all these detectors.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1a illustrates an example of a technological system in accordance with aspects of the present disclosure.

FIG. 1b illustrates a particular example of an implementation of a technological system in accordance with aspects of the present disclosure.

FIG. 1c illustrates an example variant of an organization of Internet of Things (IoTs) on an exemplary wearable device in accordance with aspects of the present disclosure.

FIG. 1d illustrates example set of sensors of devices in accordance with aspects of the present disclosure.

FIG. 2 illustrates an example of a CPS and a system for detecting anomalies in the CPS in accordance with aspects of the present disclosure.

FIG. 3 illustrates an example of an anomaly detector in accordance with aspects of the present disclosure.

FIG. 4 illustrates an example of a system for detecting anomalies in the CPS in accordance with aspects of the present disclosure.

FIG. 5 illustrates an example of a data processing pipeline in accordance with aspects of the present disclosure.

FIG. 6 illustrates an exemplary method for detecting anomalies, e.g., in a CPS or IS, in accordance with aspects of the present disclosure.

FIG. 7 presents an example of a general purpose computer system on which aspects of the present disclosure can be implemented.

### DETAILED DESCRIPTION

Exemplary aspects are described herein in the context of a system, method, and a computer program for detecting anomalies in a cyber-physical system. Those of ordinary skill in the art will realize that the following description is illustrative only and is not intended to be in any way limiting. Other aspects will readily suggest themselves to those skilled in the art having the benefit of the disclosure. Reference will now be made in detail to implementations of the example aspects as illustrated in the accompanying drawings. The same reference indicators will be used to the extent possible throughout the drawings and the following description to refer to the same or like items.

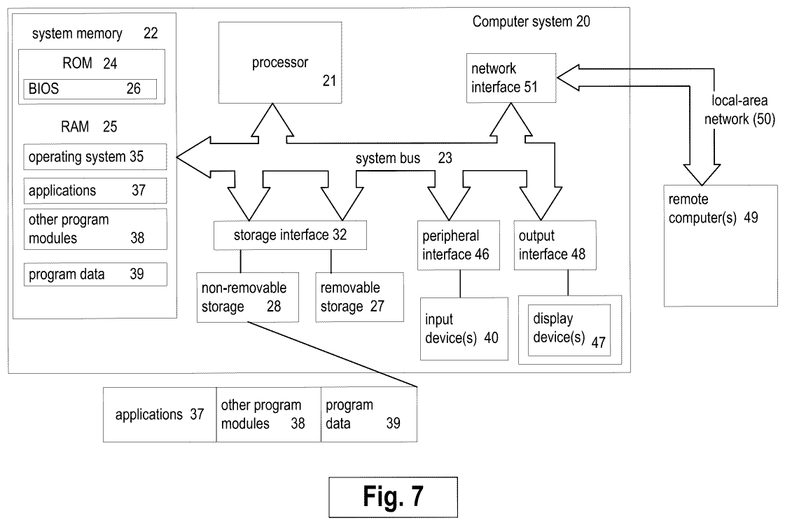

In one aspect, the present disclosure describes a system for detecting anomalies in a cyber-physical system that is implemented on a computing system, that includes real-world devices, systems, components, and groups of components realized with the use of hardware such as integrated microcircuits (application-specific integrated circuits, ASICs) or field-programmable gate arrays (FPGAs) or, for example, in the form of a combination of software and hardware such as a microprocessor system and set of program instructions, and also on neurosynaptic chips. The functionality of such means of the system may be realized solely by hardware, and also in the form of a combination, where some of the functionality of the system means is realized by software, and some by hardware. In certain aspects, some or all of the components, systems, etc., may be executed on the processor of a general-purpose computer (such as the one shown in FIG. 7). Furthermore, the system components may be realized either within a single computing device or spread out among several interconnected computing devices.

In order to clearly and concisely describe the teachings of the present disclosure, a brief glossary of terms and technical concepts is first provided below.

The term “object of control” refers to a technological object to which external impact (controlling and/or disturbing) are directed in order to change the state of the object. In one aspect, the objects are devices (for example, an electric motor) and/or technological processes (or parts of technological processes).

The term “Technological Process (TP)” refers to the process of material production, which includes a sequential change in states of the material entity (i.e., the object of labor).

“Control loop” consists of material entities and control functions necessary for automated adjustment of the values of the measured technological parameters to values of desired settings. The control loop contains sensors, controllers and actuators.

“Process Variable (PV)” refers to the current measured value of a certain part of the TP that is observed or controlled. A technological parameter can be, for example, a measurement of a sensor.

“Setpoint” refers to a supported value of a technological parameter.

A “Manipulated Variable (MV)” refers to a parameter that is adjusted so that the value of the technological parameter is maintained at the layer of the setpoint.

The term “external impact” refers to a way of changing the state of the element to which the impact is directed (for example, an element of the technological system (TS) in a certain direction). The impact from the element of the TS to another element of the TS is transmitted in the form of a signal.

The “state of the object of control” refers to a set of the essential properties of the object of control, which is expressed by the parameters of the states. The state of the object of control is changed or retained under the influence of external impact, which may include control actions from a control subsystem.

A “state parameter” refers to one or more numeric values that characterize an essential property of an object; in a special case, the state parameter comprises a numeric value of a physical quantity.

The “formal state of the object of control” is the state of the object of control corresponding to the technological map and other technological documentation (if the object of control is the TP) or the traffic schedule (if the object of control is a device).

“Control action” refers to a purposeful (the purpose of the impact is to impact the state of the object) a legitimate (provided for by the TP) external impact on the part of the subjects of the control subsystem control on the object of control, leading to a change in the state of the object of control or the retention of the state of the object of control.

A “control subject” is a device that directs the control effect to the object of control, or transfers the control effect to another control subject for transformation before directly directing the effect to the object.

The “state of the control subject” is a set of its essential properties, expressed by the parameters of the states, changed or held under the influence of external impact. A state parameter is one or more numeric values that characterize an essential property of a subject; in a special case, the state parameter may comprise a numeric value of a physical quantity.

“Essential properties” (respectively, and essential parameters of the state) of the control subject are properties that have a direct impact on the state of the object of control. At the same time, the essential properties of the object of control are the properties that have a direct impact on the controlled factors (e.g., accuracy, safety, efficiency) of the functioning of TS. For example, the compliance of cutting modes with formally specified modes, the movement of the train in accordance with the schedule, keeping the reactor temperature within acceptable limits, etc. Depending on the controlled factors, the parameters of the state of the controlled and, accordingly, the related parameters of the states of the control subjects are selected. The control subjects have a controlling effect on the object of control.

A “multi-layer management subsystem” is a set of management entities that includes several layers of control subjects.

An “information system (IS)” is a set of computing devices and means of communications therebetween.

A “cyber-physical system (CPS)” refers to an information technology concept that involves the integration of computing resources into physical processes. In such a system, sensors, equipment, and information systems are connected throughout the entire value chain that goes beyond a single enterprise or business. These systems communicate with each other using standard Internet protocols to predict, self-tune, and adapt to change. Examples of a cyber-physical system are a technological system, the Internet of Things (including wearable devices), and the Industrial Internet of Things.

The Internet of Things (IoT) refers to a computing network of physical objects (“things”) equipped with built-in network technologies to interact with each other or with the external environment. The Internet of Things includes technologies such as wearable devices, electronic vehicle systems, smart cars, smart cities, industrial systems, etc.

The Industrial Internet of Things (IIoT) consists of Internet-connected equipment and advanced analytics platforms that process data from connected devices. IIoT devices may range from small weather sensors to complex industrial robots. Despite the fact that the word “industrial” evokes associations such as warehouses, shipyards, and production halls, IIoT technologies have great potential for use in a wide variety of industries, including agriculture, healthcare, financial services, retail and advertising. The Industrial Internet of Things is a subcategory of Internet of Things.

“Object” refers to the object of monitoring, in particular, an IS or CPS.

A “technological system (TS)” is a functionally interrelated set of control entities of a multi-layer control subsystem and a object of control (TP or device), which implements, through a change in the states of management subjects, a change in the state of the object of control. The structure of the technological system is formed by the main elements of the technological system (interrelated control subjects of the multi-layer management subsystem and the object of control, as well as the connections between these elements. In the case when the object of control in the technological system is a technological process, the ultimate goal of management is to change the state of the object of labor (raw materials, blanks, etc.) through a change in the state of the object of control In the case when the object of control in the technological system is a device, the ultimate purpose of control is to change the state of the device (vehicle, space object, etc.). The functional interconnection of the elements of the device implies the interconnection of the states of these elements. In this case, there may not be a direct physical connection between the elements, in particular, there is no physical connection between the actuators and the technological operation. For example, the cutting speed is functionally related to the spindle speed, despite the fact that these state parameters are not physically related.

A “computer attack” (also a cyberattack) is a targeted impact on information systems and information and telecommunication networks by software and hardware means, carried out in order to violate the security of information in these systems and networks.

An anomaly can occur, for example, due to a computer attack, due to incorrect or illegitimate human intervention in the operation of the device or TP, due to a failure or deviation of the technological process, including those associated with periods of changing its modes, due to the transfer of control loops to manual mode or due to incorrect sensor readings, and for other reasons known in the art. The anomaly may be characterized by a deviation of parameters of the CPS.

The area of localization of the anomaly may be the time range of observation of the anomaly (time domain) and/or the place of occurrence of the anomaly—that is, an indication of the element or part of the CPS where the anomaly occurred (spatial region), for example, an indication of the sensor or its coordinates in which the anomaly occurred. For each anomaly, the area of localization of the anomaly is determined—temporally and/or spatially. For example, in order to determine the spatial areas of localization (i.e., spatial regions), the CPS may be divided into different parts according to: belonging to different TP or parts thereof, belonging to different physical or logical areas of the CPS, and according to other criteria. In one aspect, the other criteria may include criteria specified by the operator of the CPS.

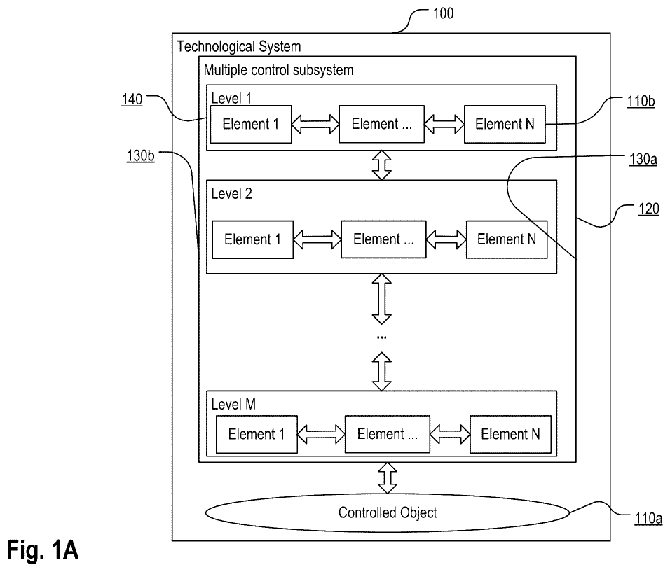

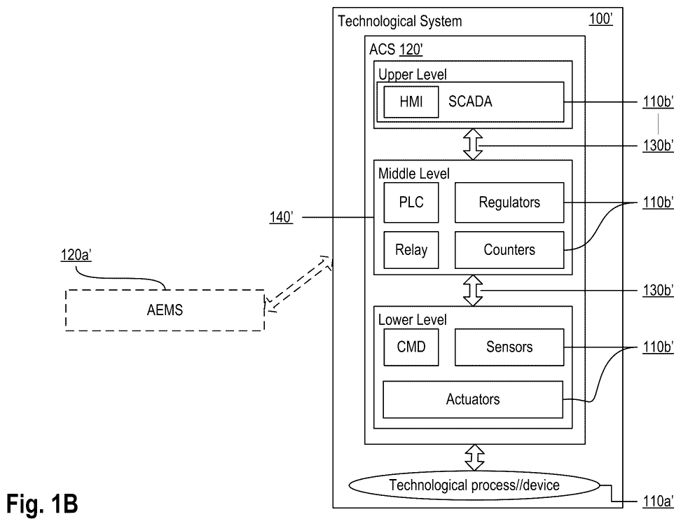

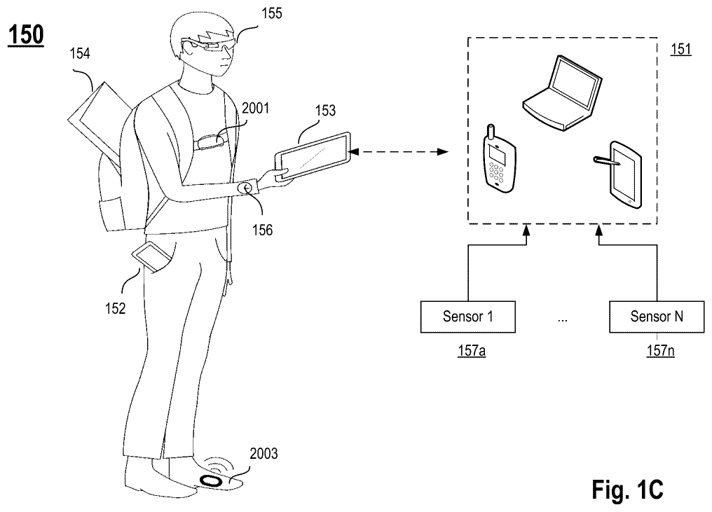

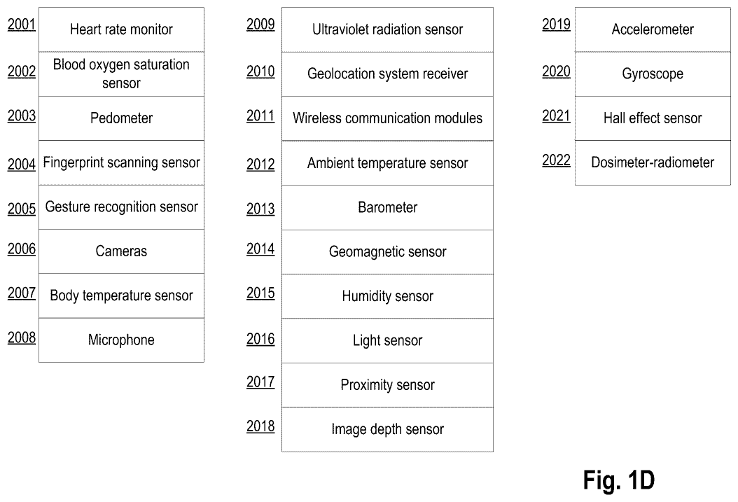

FIG. 1a illustrates an example of a technological system 100 in accordance with aspects of the present disclosure. The technological system 100 includes elements 110a and 110b. The elements 110a comprise objects of control 110a and the elements 110b comprise control subjects 110b. The objects of control 110a, control subjects 110b form a multi-layer management subsystem 120 that includes layers 1, 2, . . . , M. The control subjects 110b are grouped into layers 140. The various elements are interconnected via horizontal connections 130a and vertical connections 130b.

FIG. 1b illustrates a particular example 100′ of an implementation of a technological system 100 in accordance with aspects of the present disclosure. Thus, the example 100′ shown in FIG. 1b is a particular implementation of the technological system shown in FIG. 1a. The object of control 110a′ is a TP or device, control actions are directed to the object of control 110a′ that are generated and implemented by the automated control system (ACS) 120′. The ACS 120′ there are three layers 140′, consisting of control subjects 110b′, interconnected with each other both horizontally by horizontal connections and vertically by vertical connections 130b′ (connections between layers). It is noted that the horizontal connections within a given layer are not indicated on the figure but are regardless part of FIG. 1b. The relationships are functional, i.e., in general, a change in the state of the control subject 110b′ at one layer causes a change in the states of the associated control subjects 110b′ at this layer and other layers. Information about changes in the state of the control subject 110b′ is transmitted in the form of a signal along horizontal and vertical connections established between the control subjects 110b′. That is information about changes in the state of the subject under consideration of control entities 110b′ is an external impact in relation to other control subjects 110b′. In the ACS 120′, layers 140′ are allocated in accordance with the purpose of the control subjects 110b′. The number of layers may vary depending on the complexity of the ACS 120′. Simple systems may contain one or more lower layers. For physical communication of the elements of the TS (110a, 110b) and subsystems of the TS 100 wired networks, wireless networks, integrated circuits are used. Ethernet, industrial networks, industrial networks are used for logical communication between the elements of the TS (110a, 110b) and the subsystems of the TS 100. In addition, industrial networks and protocols of various types and standards are used, for example, Profibus, FIP, ControlNet, Interbus-S, DeviceNet, P-NET, WorldFIP, LongWork, Modbus, etc., may be used.

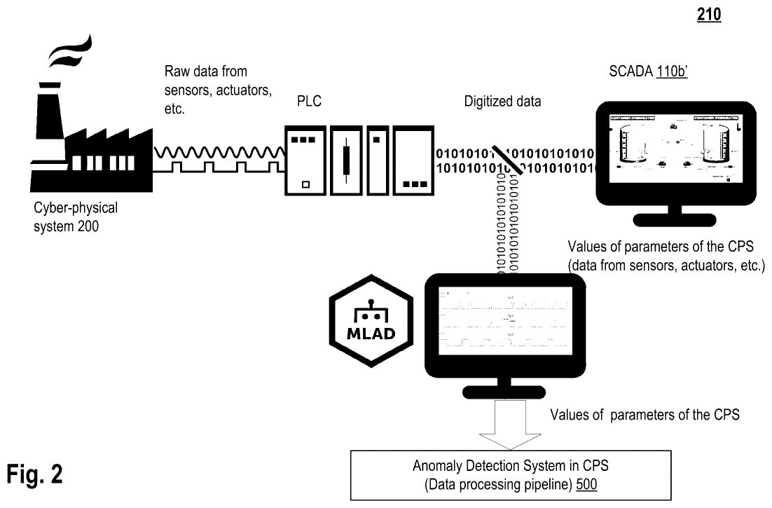

The upper layer of ACS 120′ is a layer for Supervisory Control and Data Acquisition (SCADA). Thus, the upper layer is the layer of dispatching-operator control, includes at least the following control entities 110b′: controllers, control computers, human-machine interfaces (HMI). On FIG. 1B and FIG. 2 the controllers, control computers, and HMIs are depicted within one SCADA control entity. The upper layer is designed to monitor the states of the elements (110a′, 110b′), to obtain and accumulate information about the state of the device elements (110a′, 110b′) and, if necessary, to set up them.

The middle layer of ACS 120′ is a layer of controllers (control layer) that includes at least the following control subjects 110b′: programmable logic controllers (PLC), counters, relays, regulators. Control subjects 110b′ of the “PLC” type receive information from control subjects 110b′ of “control and measuring equipment” type and control subjects 110b′ of “sensors” type. The received information is information associated with the state of the object of control 110a′. Control subjects 110b′ of the “PLC” type develop (form) a control effect in accordance with the programmed control algorithm on the control subjects 110b′ of the “executive mechanisms” type. The executive mechanisms directly implement this control action (i.e., apply to the object of control) at the lower layer, for example via actuators and regulators. The actuator is a part of the executive device (equipment). The regulators, for example, proportional-integral-differential (PID) controllers are devices in the feedback control loop.

The lower layer of ACS 120′ (Input/Output layer) is the layer of control subjects 110b′ such as sensors and control and measuring devices (CMD) that control the state of the object of control 110a′, as well as actuators. Actuators directly affect the state of the controlled object 110a′ to bring it into line with the formal state; i.e., the state corresponding to the technological task, technological map or other technological process documentation (in the case when the object is a TP) or a traffic schedule (in the case of the object being a device). At the lower layer, signals from control subjects 110b′ of the “sensors” type are coordinated with the inputs of the control subjects 110b′ of the middle layer, and the control subjects 110b′ of the “PLC” type are coordinated with the control subjects 110b′ such as the “actuators” that implement them. The actuator moves the portion being regulated (also referred to as a regulatory body) in accordance with signals coming from the regulator or control device. Actuators are the last link in the automatic control circuit and generally consist of the following elements (e.g., auxiliary devices):
amplification devices (contactor, frequency converter, amplifier, etc.);
actuator (electric, pneumatic, hydraulic drive) with feedback elements (output shaft position sensors, end position signaling, manual drive, etc.); and
regulatory body (valves, valves, flaps, gate valves, etc.).

Depending on the conditions of application, the actuators may differ structurally from each other. The main elements of actuators usually include actuators and regulatory bodies. In one example, the element that performs the actuation to control entities is simply referred to as an actuator.

It is worth noting that to solve the problems of planning and management of the enterprise, Automatic Enterprise Management System (AEMS) 120a′ is used, which is part of the ACS 120′. The AEMS is an application software package that may be used to automate software tasks across an IT infrastructure of an enterprise based on needs of the enterprise. For example, the tasks may be for managing customer interfaces, managing resources across the enterprise, managing supply chain for producing a product of the enterprise or for providing a service, and the like. Thus, the ACS 120′ of the present disclosure includes AEMS applications for automating software tasks of the enterprise.

FIG. 1c illustrates an example variant 150 of an organization of Internet of Things (IoTs) on an exemplary wearable device in accordance with aspects of the present disclosure. The technological system includes many different computer devices 151 of users. Among the devices 151 of the user may be, for example, a smartphone 152, a tablet 153, a laptop 154, wearable devices, such as augmented reality glasses 155, a “smart” watch 156. The devices 151 of the user include many different sensors 157a-157n, for example, a heart rate monitor 2001 and a pedometer 2003.

It is worth noting that the sensors 157a-157n may reside on a single device 151 of the user or on several devices. Moreover, some sensors 157a-157n may reside on multiple devices 151 of the user simultaneously. A portion of the sensors 157a-157n may reside on multiple devices 151 of the user. In addition, the sensors may be presented in several copies. For example, the Bluetooth module may reside on all devices 151 of the user, and the smartphone 152 may comprise two or more microphones necessary for noise reduction and for distance determination to a sound source.

FIG. 1d illustrates example set of sensors of devices 151 in accordance with aspects of the present disclosure. Among the sensors 157a-157n may be, for example, the following:
a heart rate monitor 2001 used to determine the user's pulse rate. In one example, the heart rate monitor 2001 may comprise electrodes and measure an electrocardiogram;
blood oxygen saturation sensor 2002;
pedometer 2003;
fingerprint scanning sensor 2004;
gesture recognition sensor 2005;
cameras 2006, for example, a camera directed at the user's eyes, used to determine the movement of the user's eyes and/or to authenticate the user's identity through the iris or retina of the eye, a camera directed at the environment surrounding the user's device, and the like;
the user's body temperature sensor 2007 (e.g., a thermometer having direct contact with the user's body or non-contact thermometer);
microphone 2008;
ultraviolet radiation sensor 2009;
geolocation system receiver 2010, e.g., GPS receiver, GLONASS, BeiDou, Galileo, DORIS, IRNSS, QZSS, etc.;
one or more wireless communication modules (e.g., GSM, LTE, NFC, Bluetooth, Wi-Fi, and others) 2011;
ambient temperature sensor 2012;
barometer 2013;
geomagnetic sensor 2014 (electronic compass);
humidity sensor 2015;
light sensor 2016;
proximity sensor 2017;
image depth sensor 2018;
accelerometer 2019;
gyroscope 2020;
Hall effect sensor 2021 (magnetic field sensor); and
dosimeter-radiometer 2022.

FIG. 2 illustrates an example 210 of a Cyber-Physical System (CPS) 200 and a system 500 for detecting anomalies in the CPS 200 in accordance with aspects of the present disclosure. The CPS 200 has certain characteristics. The system 500 for detecting the anomalies may also be referred to as the data processing pipeline 500. For ease of understanding, the CPS 200 is presented in a simplified form. Examples of CPS 200 are the previously described technological system (TS) 100 (see FIGS. 1a-1b), the Internet of Things (see FIG. 1c-1d), industrial Internet of things, IP. For clarity, further in the present disclosure, the TS will be described as being an exemplary implementation of CPS 200. As mentioned above in conjunction with the descriptions of FIGS. 1a-1b, the CPS 200 comprises a plurality of control entities, such as sensors, actuators, PID controllers, etc. The data of said control entities is transmitted in raw form to the PLC. An analog signal may be used to transmit data. The PLC performs data processing and data conversion from analog to digital form—thereby converting the analog information into values of parameters of the CPS, including the technological parameters of the CPS (that is, into the telemetry data of the CPS 200), and into events (for example, an activation of a particular sensor, triggering of sensor alarms, invocation of individual commands, and others). The values of the parameters of the CPS are then transmitted to the SCADA 110b′ system and the system for the detection of anomalies in the CPS 500, as shown in FIG. 2.

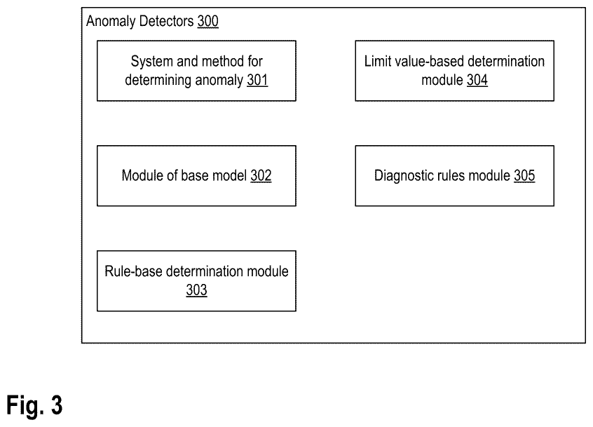

The anomaly detection system in the CPS 500 comprises anomaly detectors 300 (also anomaly detection modules, hereinafter referred to as detectors). FIG. 3 illustrates an example of an anomaly detector 300 in accordance with aspects of the present disclosure.

Anomaly detectors 300 are used to detect anomalies in the CPS 200, as well as to determine related information about the detected anomalies. In one example, the anomaly information in the CPS 200 includes information about the anomaly, such as the area of localization of the anomaly, the values of the parameters of the CPS at each point in the time range of the anomaly observation, the contribution of each parameter of the CPS to the anomaly, information about the method of detecting said anomaly (i.e., about the detector 300).

In another aspect, the anomaly information in CPS 200 further includes, for each parameter of a CPS, at least one of: a time series of values, the current value of the deviation of the predicted value from the actual value, a smoothed value of the deviation of the predicted value from the actual value.

In another aspect, information about anomalies in the CPS 200 additionally includes information one or more of: maximum values of the parameters of the CPS, minimum values of the parameters of the CPS, and average value of the parameters of the CPS taken during the anomaly period; and other statistical and deterministic characteristics, including sample variances and quantiles, the Fourier spectrum and the wavelet of transformations, convolutional operators from the parameters of the CPS.

In one aspect, the anomaly detectors 300 may be a system and method for determining an anomaly in CPS 301, (previously described in U.S. Pat. Nos. 11,175,976 and 11,494,252 and incorporated herein by reference), which determine the anomaly by predicting the values of a subset of parameters of the CPS. It is noted that in U.S. Pat. Nos. 11,175,976 and 11,494,252, the term “CPS features” is used to correspond to the parameters of the CPS of the present disclosure. Then, the method of the present disclosure may be used for determining the total prediction error for a subset of parameters of the CPS, determining whether the determined total prediction error exceeds a threshold value, when the threshold value is exceeded, determining that an anomaly is detected in CPS 200.

In addition, in one aspect, the method of the present disclosure further comprises determining the contribution of a subset of parameters of the CPS to the total forecast error as the contribution of the forecast error of the corresponding parameter of the CPS to the overall forecast error.

In one aspect, the anomaly detectors 300 may include a module of the base model 302 designed to apply a trained machine learning model to detect anomalies from values of a subset of parameters of the CPS (hereinafter referred to as the base model). In this case, the base model may be trained on data from a training sample which may or may not include known anomalies in the CPS 200. The training sample may also include values of a subset of parameters of the CPS over a period of time—that is, a supervisor-driven machine learning model may be used. In addition, an unsupervised machine learning model may be used as a base model. To improve the quality of the base model, the trained base model may be tested and validated on test samples and validation samples, respectively. In this case, the test samples and validation samples may include known anomalies and values of a subset of parameters of the CPS for a certain period of time preceding the known anomaly in CPS 200, but while differing from the training sample.

In yet another aspect, the anomaly detectors 300 may include a rule-based determination module 303 to be used for determining anomaly determination rules. Such rules may be pre-formed and obtained from the CPS operator via a feedback interface and may comprise conditions applied to values of a subset of parameters of the CPS at which the anomaly is determined.

In yet another aspect, the anomaly detectors 300 may include a limit value-based determination module 304 that determines an anomaly when the value of at least one parameter of the CPS from a subset of parameters of the CPS has exceeded a predetermined range of values for said parameter of the CPS, wherein said ranges of values may be calculated from the characteristic values or documentation for the CPS 200 or may be obtained from a CPS operator via a feedback interface.

In yet another aspect, the anomaly detectors 300 may include a diagnostic rules module 305 which may be used to form diagnostic rules by specifying a set of parameters of the CPS used in the diagnostic rule. The diagnostic rules module 305 may calculate the values of the CPS auxiliary parameter, use a given set of parameters of the CPS in accordance with the formed diagnostic rules. As a result, the diagnostic rules module 305 determines an anomaly in the CPS 200 based on the values of all parameters of the CPS.

In yet another aspect, the anomaly detectors 300 may include a graphical interface system for determining the anomaly manually by the CPS operator. This approach for manually determining the anomaly is described in U.S. Pat. No. 11,175,976. Once the anomaly is determined, the information about the anomaly may be transmitted via a feedback interface.

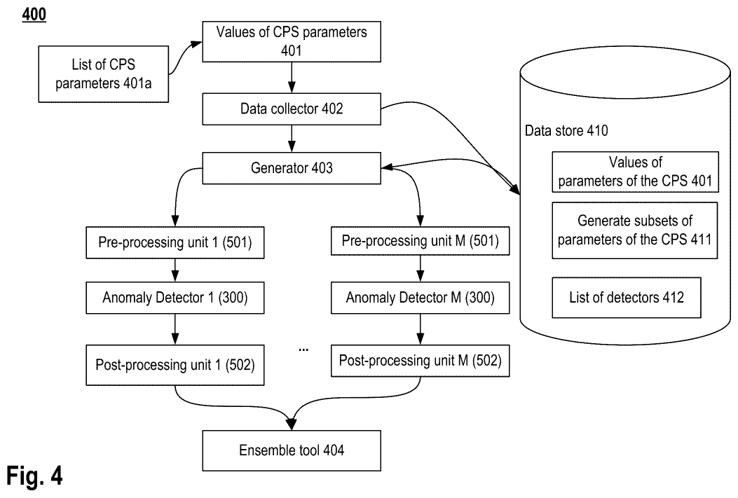

FIG. 4 illustrates an example of a system 400 for detecting anomalies in the CPS 200 in accordance with aspects of the present disclosure. For clarity, FIG. 4 also shows the data processing pipeline 500. In one aspect, the data of the CPS 200 may be collected either in real time, the data may be read from files (for example, the “csv” format) or databases, or the data may be obtained from third-party applications. The data may be represented as a list of parameters of the CPS 401a. The list of parameters of the CPS 401a and measured values of said parameters of the CPS 401 (e.g., in a “timestamp—value of the parameter of the CPS” format) are stored in the data storage 410. In one aspect, the timestamp may correspond to the actual measurement time, storage time, or sampling time of that parameter of the CPS. Therefore, the actual time of data acquisition by the data collector 402 may differ from the time indicated in the timestamp due to delays in data transmission, for example, due to a heavy data transfer load or other reasons. In addition, the timestamp may correspond to the time when the value of the parameter of the CPS was obtained. In another aspect, the timestamp is the time when the value of the parameter of the CPS was written to the data storage 410.

In one aspect, the values of a parameter of the CPS 401 include at least one of the following values:
sensor measurement;
the value of the controlled parameter of the actuator;
the setpoint of the executive mechanism;
input values of the proportional-integral-differentiating regulator (PID-regulator); and
the value of the output signal of the PID controller.

In one aspect, the data of the CPS 200 (i.e., the values of parameters of CPS 401) are collected in one of the possible ways:
simultaneously from the entire CPS 200 with the indication of the parameters of the CPS 401a;
as several separate data streams from separate parts of the CPS 200, indicating the parameters of the CPS 401a contained in each data stream.

After obtaining the values of the parameters of the CPS 401 by the data collector 402, the system 400 may create a register of the parameters of the CPS represented in this data, after which this information may be received by the generator 403, which is configured to:
a) generate subsets of parameters of the CPS 411 from among the parameters of the CPS 401a, wherein these subsets 411 are stored in data storage 410;
b) select a detector from the list of detectors 412 for each of the subsets of the parameters of the CPS 411, wherein the list of detectors 412 includes part or all of the detectors 300 shown in FIG. 3 and is contained in the data storage 410; and
c) select pre-processing and post-processing units for the selected detectors 300.

It is worth noting that all subsets of 411 together form the set of all parameters of the CPS s. It is also worth noting that these subsets of 411 may coincide, intersect, or not intersect. In one aspect, some parameters of the CPS may not be included in any of the subsets of 411. In this case, all subsets of 411 together, they form a set of all parameters of the CPS except for those parameters not included in any of the subsets 411.

It is worth noting that the data storage 410 is intended both for storing data and for providing access to data including the obtained values of the parameters of the CPS 401, the generated subsets of the parameters of the CPS 411 and the list of detectors 412. Moreover, the number of detectors 412 may be set in advance.

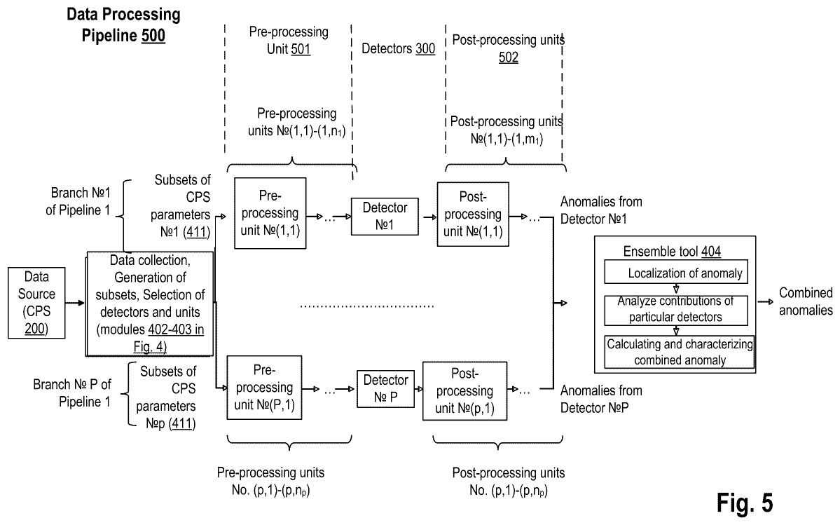

In one aspect, the pre-processing units 501 are configured to process each subset of the parameters of the CPS of 411 prior to transmitting to the respective anomaly detector 300 (e.g., a combination processing unit comprising pretreatment units of FIG. 5). Each anomaly detector 300 corresponds to its set of pre-processing units 501 from one or more blocks. Each of the post-processing units 502 is designed to process the output of a corresponding anomaly detector 300 before transmitting it to the ensemble tool 404 (shown in more detail in FIG. 5). Each anomaly detector 300 corresponds to its own set of post-processing units 502 from one or more blocks. CPS parameters of 401a are divided into subsets of the parameters of the CPS 411 according to a certain principle, for example, depending on the characteristics of subsets (according to belonging to a particular type of equipment), according to the physical meaning (by belonging to the same physical process, by the same type of physical parameters of the CPS, for example, temperature or pressure, by danger to TP, etc.).

In one aspect, a subset of the parameters of the CPS 411 is selected taking into account at least one of the following characteristics of the subset:
the significance of the parameters of the CPS for TP;
belonging of the parameters of the CPS to a particular type of equipment;
belonging to one physical (chemical or other) TP; and
the uniformity of the physical parameters of the CPS in a subset (temperature, pressure, and so on).

In order to add clarity, the selection of anomaly detector 300 for subsets of parameters of the CPS 411, the selection of data pipeline blocks for the data processing pipeline 500, and the results of the ensemble tool 404 are described below.

Selection of Anomaly Detector 300

For each of the subsets of parameters of the CPS 411, the selection of the anomaly detector 300 is made taking into account the characteristics of such an anomaly detector 300 and the characteristics of a subset of parameters of the CPS 411 used to determine anomalies by this anomaly detector 300. Thus, for a given subset of the parameters of the CPS 411, the anomaly detector 300 may be selected based on at least one of the following considerations: the accuracy and completeness of the determination of anomalies by this anomaly detector 300 for this subset of parameters of the CPS 411, the performance of the anomaly detector 300 on this subset of parameters of the CPS 411, expert knowledge of a subset of parameters of the CPS 411 (if the parameters of the CPS of the subset relate to a particular TP, type of equipment, etc.), and others.

In one aspect, the anomaly detector 300 and a corresponding subset of parameters of the CPS 411 are selected, taking into account, in particular, at least one of the following:
characteristics of CPS 200;
a list of CPS 401a parameters from a subset of CPS 411 parameters; and
the type and amount of data.

In yet another aspect, the values of the parameter of the CPS are further taken into account when selecting the anomaly detector 300 and the corresponding subset of the parameters of the CPS 411.

Thus, for CPS 200 operating with rapid time processes (about 1-10 ms), characteristic, for example, for electrical equipment, timely detection of the anomaly becomes critically important, which, in turn, imposes serious restrictions on the number of parameters processed by the anomaly detector from a subset of parameters of the CPS 411, and the choice of the anomaly detector itself—here preference is given to threshold detectors or detectors based on simple diagnostic rules. On the contrary, for slow-flowing, inert processes characteristic of the petrochemical industry with their huge number of parameters (from 1000-10,000) and reaction times of the order of 1-10 minutes, subsets 411 are chosen consisting of parameters of the CPS covering x certain CPS settings, such as atmospheric or vacuum columns, and containing hundreds of such parameters of the CPS. As an anomaly detector for such subsets 411, as a rule, trained statistical or neural network models are taken, taking into account the complexity of the ongoing processes in such installations or CPS.

In another aspect, the anomaly detector 300 and a corresponding subset of parameters of the CPS 411 are selected, taking into account, in particular, at least one of the following characteristics associated with the anomaly detector 300:
quality metrics;
the results of the Receiver Operating Characteristics (ROC) curve analysis;
run time; and
the amount of resources used by the computer.

In yet another aspect, the characteristics associated with the anomaly detector 300 include the performance of the anomaly detector 300, e.g., the amount of memory, the processor time, the number of processor cores of the computer, the number of computers connected over the network and involved in the implementation of the method, and others).

Selecting Data Processing Pipeline Blocks

FIG. 5 illustrates an example of a data processing pipeline 500 in accordance with aspects of the present disclosure. The processing pipeline 500 includes a set of preprocessing units 501, anomaly detector 300, and post-processing units 502.

The blocks of pipeline 500, in particular the pre-processing units 501 and post-processing units 502, are functional modules implemented on a computer processor (see example in FIG. 7) with the ability to perform a given functionality. Each selected anomaly detector 300 has its own set of pre-processing units 501 and post-processing units 502. Information about the pre-processing units 501 and post-processing units 502 may be contained, for example, in a list of detectors 412 or in a separate list in the data storage 410. The pre-processing unit 501 is used to process data from a subset of the parameters of the CPS 411 selected for the anomaly detector 300 and received from the generator 403, or to process data received from other preprocessing units 501. The data of the last preprocessing unit 501 is transmitted to the detector unit 300. The block of post-processing unit 502 is used to process the output of the corresponding anomaly detector 300 (i.e., information about detected anomalies). The last of the post-processing units transmits the processed data to the ensemble tool 404.

For processing the input data stream, the following pre-processing units 501 can be used: alignment unit and time alignment unit, data filtering unit, uniform grid data interpolation unit, data normalization and repackaging unit and other units, whereas for post-processing units 502 typically bringing information about the anomalies found into some pre-approved unified form to facilitate their further ensemble.

The selection of the pre-processing units 501 and post-processing units 502 depends on the selection of the anomaly detector 300 and the desired output information about the anomalies found.

In one aspect, before transmitting the selected data to the anomaly detectors 300, the data is further processed by the pre-processing unit 501, including at least one of the following steps:
data buffering with a time buffer of a pre-determined length, e.g., Δt;
filtering (deleting) of invalid data or data that was received with a delay greater than a pre-determined length of time, e.g., Δt;
reordering based on time points of obtaining the values of parameters 401 of the CPS;
filling in gaps in the values of parameters 401 of the CPS;
interpolation to a uniform grid;
normalization of values of the parameter 401 of the CPS; and
repackaging the values parameters of the CPS for processing by the anomaly detector 300.

After testing, the anomaly detector 300, regardless of its type, may include such information about the anomaly (also the characteristics of the anomaly) as the time interval for observing the anomaly, the contribution of each parameter of the CPS to the anomaly, information about the anomaly detector 300 that detected the anomaly, detected anomalies list, values of the CPS 401 parameters at each moment of the anomaly time interval, and others. In addition, an extended set of anomaly characteristics can be calculated, and such a calculation is made in post-processing units 502. The postprocessing units 502 may include: blocks for assessing the danger of anomalies, in particular defects, blocks for determining types of such anomalies and sizing of such anomalies, blocks for normalizing and unifying the output information about anomalies, and other blocks. It should be noted that if it is impossible to calculate any characteristic of an anomaly in a particular anomaly detector 300, the output information normalization unit forcibly sets this characteristic for some pre-selected value.

In one aspect, other characteristics of the anomaly associated with the anomaly detector 300 that identified the anomaly can be calculated, for example, the following:
the hazard class of the anomaly detected by the anomaly detector 300, its type, dimensions and other similar characteristics of the anomaly;
the probability of determining the anomaly by the anomaly detector 300;
the values of deviations of the predicted values of the parameters of the CPS from their true values or default values, the values of deviations from the setpoints, the root mean square (RMS) deviations of both individual parameters of the CPS and the entire set of parameters of the CPS used in this anomaly detector 300;
maximum or average values of deviations of the observed values of the parameters of the CPS from certain predetermined limits, duration and frequency of such deviations; and
the performance of this anomaly detector 300 in detecting an anomaly, for example, the amount of memory, CPU time, the number of processor cores of the computer, the number of computers connected over the network and participating in the implementation of the method, and others).

Data Processing Using the Data Processing Pipeline 500

After the formation of subsets of the parameters of the CPS 411, the list of detectors 412 and the pre-processing blocks 501 and post-processing 502, the operation of the anomaly determination system is as follows. First, the data from the data collector 402 is divided into parallel streams (without duplication) in accordance with the separation of the parameters of CPS 401 into to subsets of the parameters of the CPS 411, and then each subset 411 is directed to the respective one or more preprocessing units 501 to prepare the data for processing by the appropriate anomaly detector 300. The prepared data is then processed by said anomaly detector 300, which results in a stream of anomalies and other related information, such as the probability of an anomaly, hazard class of the anomaly, spatial and temporal dimensions, method of detection, and others information determined by the anomaly detector 300. Then, the anomaly stream and the other related information are processed by the post-processing units 502 to bring this stream into a unified form that is the same for all anomaly detectors 300. Thus, in fact, there is a set of parallel branches for processing subsets of data pipeline 500, each individual branch processes its own subset of data and has its own tools for preparing this data, identifying anomalies and bringing them into a uniform form. Thus, each pipeline branch is a group (or set) of modules designed to process a single data stream, consisting of an anomaly detector 300, a corresponding preprocessing unit 501, and a corresponding post-processing unit 502.

It is worth noting that the processing of the incoming set of parameters of the CPS by the various branches of the pipeline 500 is generally uneven in time, so anomaly data from some branches may come with a long delay relative to other branches. To exclude situations in which the ensemble tool 404 will operate in the absence of information from any branches of the pipeline 500, buffering of the anomaly stream included in the ensemble 404 may be used. This buffering is similar to the buffering of these parameters of the CPS entering individual branches.

As shown in FIG. 5, the data is obtained from a data source, e.g., from the CPS 200, and then by data collector 402 and generator 403 (see also FIG. 4, elements “402-403”) processes and forms subsets of the parameters of the CPS 411 and select the anomaly detectors 300 from the list of detectors 412 for each subset 411. The processed data is further forked into p branches of the pipeline 500, each branch transmitting a corresponding subset 411. Thus, branch No. 1 of pipeline 500 receives subset No. 1, and processes the received subset with pre-processing blocks No. (1, 1)-(1, n₁), then performs the anomaly detection via the anomaly detector No. 1, and post-processes with post-processing blocks No. (1, 1)-(1, m₁). Once, all the branches of the pipeline 500 are processed, the processed data from all branches ranging from branch No. 1 to branch number p of the pipeline 500 are transmitted to the ensemble tool 404.

Processing by Ensemble tool and Obtaining Ensemble results

The ensemble tool 404 serves to detect a combined anomaly (also a composite/resulting anomaly) in the CPS 200 by ensembled results (i.e., data fusion or data merging) received from selected anomaly detectors 300. The ensemble tool 404 collects all identified anomalies from all branches of the data processing pipeline 500, presented in some universal and predetermined form. This type can be dictated by the peculiarity of the TP and the anomalies detected in it, the peculiarities of the available means of determining anomalies, the characteristics of the data, etc. So, for the above example in-pipe diagnostics information about the anomaly from each of the means of non-destructive testing has the following form—the frame (local area) of the defect, the type of defect, its dimensions and the type of control.

After collecting the results obtained from all the selected anomaly detectors 300, namely, all information about all anomalies detected by the anomaly detectors 300 over a certain time, the ensemble 404 conducts at least one of the following:
combining anomaly localization regions from individual anomaly detectors 300 in order to localize common anomalies, wherein said areas identify (localize) anomalies in space (indicating an element or part of the CPS where the anomaly occurred) and/or time (the range of time of observation of the anomaly);
analysis of the contribution of a particular anomaly detector 300 to the combined anomaly; and
calculation of predetermined characteristics of the combined anomaly using the characteristics of the anomalies obtained from each of the anomaly detectors 300 and information about its contribution—that is, based on the localization region of the combined anomaly and the values of all parameters of the CPS.

The combination of areas or timestamps of anomalies is carried out on the basis of an analysis of spatial or temporal regions marked as an anomaly by one or another anomaly detector 300. Thus, the anomaly regions obtained from different anomaly detectors 300 may be combined into one common region of the combined anomaly (also the region of localization of the combined anomaly and) when at least one of the following conditions is met:
if the spatial or temporal intersection of the above areas exceeds a certain percentage of the combined area;
if the centers of the respective areas lie in a certain spatial or temporal range; and
if a specially trained neural network marks these regions as relating to a single combined anomaly, in particular a combined defect.

It is worth noting that at the stage of combining anomalies from various anomaly detectors 300, anomalies of three types will be obtained, namely, anomalies obtained by combining regions from all anomaly detectors 300, anomalies obtained by combining regions from only a part of the anomaly detectors 300, and anomalies obtained by only one of the anomaly detectors 300. All these anomalies after the combination step are also called combined anomalies, even if these are anomalies of the latter type.

It is worth noting that if the spatial and/or temporal regions of the anomalies detected by the anomaly detectors 300 differ significantly according to one of the above conditions, these anomalies will not be combined into one combined anomaly but will be considered separate anomalies. For example, anomalies may occur in different TPs or in different parts of the CPS 200. For example, anomalies may occur in different TPs or in different parts of the CPS 200—that is, the difference in the spatial regions of anomalies. In another example, anomalies may occur with a significant time difference, which also indicates that these are different anomalies of one part of the CPS 200. In another example, anomalies can occur and be detected by anomaly detectors 300 in different places and with a large time difference, which also indicates different anomalies in both time and space.

After obtaining the localization region of the combined anomaly, the contribution of certain anomaly detectors 300 to this combined anomaly is analyzed. Thus, a feature vector corresponding to the total number of anomaly detectors 300 is introduced, and the contribution of a particular anomaly detector 300 is expressed by a number calculated either by the contribution of the spatial or temporal region of the anomaly obtained by this anomaly detector 300, into a combined anomaly, either by the degree of proximity of the center of this and the combined anomaly, or by using a pretrained neural network that evaluates such a contribution. Note that in the absence of a combined anomaly of a particular anomaly detector 300 in the formation, its contribution is set as zero. Also note that if there is information about the degree of reliability or criticality of a particular anomaly detector 300 for a given TP in the CPS 200, in which the said detector detects an anomaly, the contribution of this anomaly detector 300 is changed, for example, significantly increased or decreased.

After calculating the contribution of each of the anomaly detectors 300 to the combined anomaly, the predetermined characteristics of the combined anomaly are calculated based on the localization region of the combined anomaly and the values of all parameters of the CPS included in all subsets of the parameters of the CPS of the pipeline 500. An example of such characterization is described in U.S. patent application Ser. No. 17/973,796, and can be carried out on the basis of only local data of the parameters of the CPS of the anomaly, taking into account the vector of contributions of the anomaly detectors 300 to this anomaly, taking into account the characteristics of the anomalies obtained from each of the anomaly detectors 300 or in any combination from the foregoing. It is worth noting that at the same stage, if necessary, anomalies are filtered either with predetermined characteristics, or determined by only one anomaly detector 300, or determined by a pre-trained neural network, or according to a certain pre-selected set of rules.

So, at the output of the ensemble 404, the TP operator receives a set of combined anomalies with their calculated characteristics, which may include the probability of the anomaly, its hazard class, spatial and temporal dimensions, detection method or method, and others.

The following is an example in which the use of a definition module based on limit values 304 can be applied to those parameters of the CPS that are critical to a particular TP in order to isolate critical anomalies (the first subset). In this case, the remaining parameters of the CPS (the second subset) will be analyzed in another way, such as system and method for determining anomaly 301. In this case, the ensemble tool 404 has information about the method of detecting the anomaly and, when an anomaly is detected, the module 304 determines only the combined anomaly with some probability and hazard class (for example, 80% of the “second” hazard class). In contrast, when an anomaly is detected by both the anomaly detectors 300 simultaneously determine the combined anomaly with a higher probability and a greater hazard class (e.g., 90%-100%, probability of “first” hazard class), followed by isolating the critical anomalies based on a threshold information and sending to the operator of the CPS.

Another example is when the parameters of the CPS 401a are divided into subsets of the parameters of the CPS 411 according to a certain principle. For each subset of the parameters of the CPS 411, their respective anomaly detector 300 is selected. Then, each branch of the data processing pipeline 500 separately determines and evaluates the probability and layer of criticality of the anomalies found and sends this information to the ensemble tool 404. It is worth noting that the layer of criticality of anomalies determined by the parameters of the CPS 401a and each subset of the parameters of the CPS 411 can be set, for example, by: the operator of the CPS via a feedback interface, using a pre-trained machine learning model to assess the layer of criticality, or using statistical data on previously defined anomalies.

The ensemble tool 404 combines the results obtained from the selected anomaly detectors 300, namely all the anomalies obtained, by assessing the proximity of the centers of the corresponding anomaly regions and then calculating the probability and hazard class of the anomaly, in particular by weight averaging for criticality and probability in all methods that determined the corresponding anomaly (i.e., detectors 300). In the averaging, the vector corresponding to the detection (value 1) or non-detection (value 0) of a given anomaly by one means or another is used. In this case, if the total probability of the anomaly exceeds the specified threshold (for example, more than 0.5), then the anomaly is confirmed, otherwise it is not confirmed and is filtered out.

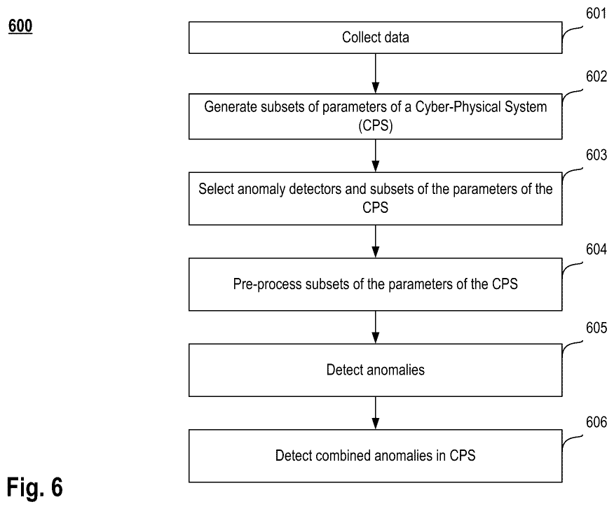

FIG. 6 illustrates an exemplary method 600 for detecting anomalies, e.g., in a CPS or IS, in accordance with aspects of the present disclosure.

In step 601, for a list of parameters of the CPS 401a, method 600 collects data containing the values of the parameters of the CPS 401.

In step 602, method 600 generates at least two subsets of parameters of the CPS 411 from the collected data.

In step 603, method 600 selects at least two anomaly detectors 300 from the list of detectors 412 and selects at least one corresponding subset of the parameters of the CPS 411 for each selected anomaly detector 300.

In step 604, method 600 pre-processes each subset of the parameters of the CPS 411 and transmits an output of the pre-processing to the corresponding anomaly detector 300.

In step 605, for each pre-processed subset of the parameters of the CPS 411, method 600 detects anomalies in the data using the corresponding respective anomaly detector 300.

In step 606, using the ensemble tool 404, method 600 detects a combined anomaly in the CPS by combining and processing results obtained from the selected at least two anomaly detectors 300.

It is worth noting that steps 604 and 605 may take place in parallel for each subset of the parameters of CPS 411. For example, one of the anomaly detectors 300 may pre-detect the anomaly in one millisecond and transmit the result to the ensemble tool 404, while the second detector may require one second to pre-detect the anomaly. Particular aspects presented earlier in FIG. 2-FIG. 5, are also applicable to the method of FIG. 6.

In one aspect, the method 600 further comprises post-processing the detected anomalies from each selected anomaly detector; and combining the post-processed detected anomalies.

In one aspect, the selecting of the at least two anomaly detectors and the at least one corresponding subset of the parameters of the CPS for each selected anomaly detector is performed based on at least one of: characteristics of the CPS; a list of parameters of the CPS and their values from a subset of parameters of the CPS; and types of the collected data and an amount of the collected data.

In one aspect, the selecting of the at least two anomaly detectors and the at least one corresponding subset of the parameters of the CPS for each selected anomaly detector is performed based on at least one of: a quality metric; Receiver Operating Characteristics (ROC) curve analysis results; execution time; and an amount of resources used by a computer performing the anomaly detection.

In one aspect, the pre-processing of a subset of the parameters of the CPS includes at least of one: data buffering with a time buffer of a pre-determined length; filtering of invalid data or data that arrived with a delay greater than a pre-determined length of time; reordering based on time points of obtaining the values of parameters of the CPS; filling in gaps in the values of parameters of the CPS; interpolation to a uniform grid; normalization of values of the parameter of the CPS; and repackaging the values parameters of the CPS for processing by the anomaly detector.

In one aspect, a detector of the at least two anomaly detectors detects anomalies by at least one of: detecting anomalies when a forecast error exceeds a pre-determined threshold value, wherein the forecast error is computed by predicting values of the parameters of the CPS and then determines a total forecast error for the values of the parameters of the CPS; detecting anomalies by applying a machine learning model based on the values of the parameters of the CPS; detecting anomalies when a rule for detecting anomalies is applied; and detecting anomalies by comparing the values of the parameters of the CPS with limit values of ranges of values established for the respective parameters.

In one aspect, a value of at least one of the parameters of the CPS comprises at least one of: a sensor measurement; a value of a controlled parameter of an actuator; a setpoint of an executive mechanism; a value of at least one input signal of a proportional-integral-differentiating (PID) regulator; and a value of an output signal of the PID controller.

In one aspect, values of the parameters of the CPS are collected from the CPS at a same time interval with an indication of the parameters of the CPS or from indication parts of the CPS in a form of a plurality of separate fluxes of values of the parameters of the CPS indicating the parameters contained in each stream.

In one aspect, result obtained from the selected at least two anomaly detectors are combined in at least one of the following ways: by combining anomaly localization regions from individual anomaly detectors such as common anomalies are localized, wherein said regions determine anomalies in space and/or time; by analyzing contributions of each detector to the combined anomaly; and by calculating predetermined characteristics of the combined anomaly using characteristics of the anomalies obtained from each of the detectors and information about respective contributions to the combined anomaly.

In one aspect, the combining of the anomaly localization regions is performed by: determining when a spatial or temporal region exceeds a predetermined percentage of the combined area; determining when centers of anomaly localization regions lie in a certain spatial or temporal region; and determining when a trained neural network identified the region as a region that belongs to a combined anomaly.

In one aspect, a contribution of a particular anomaly detector to the combined anomaly is determined by setting a feature vector corresponding to the total number of anomaly detectors, and by performing at least one of the following actions: equating the contribution of the particular anomaly to the combined anomaly to a number calculated from the contribution of the spatial or temporal region of the anomaly obtained by the particular detector to the combined anomaly; determining the contribution of the particular anomaly by a degree of proximity to the center of the combined anomaly; determining the contribution of the particular anomaly by applying a pretrained neural network that evaluates contributions; when a combined anomaly of the particular detector is not present in the formation, setting the contribution to zero; and when there is information about a degree of reliability or criticality of a particular detector for a technological process (TP) of the CPS in which the said detector detects an anomaly, changing the contribution of the detector based on the information about the degree of reliability or criticality.

In one aspect, after identifying at least one anomaly by each selected anomaly detector, the output data is further post-processed, wherein the post-processing includes: calculating an extended set of anomaly characteristics, including anomaly hazard assessment, determining types and sizes of the anomalies, normalizing and unifying the output information about anomalies, and detecting the combined anomaly by combining results obtained from the selected detectors.

In one aspect, when calculating the characteristics of the anomalies is not feasible or possible, setting a pre-determined value for the characteristics of the anomaly for which the calculation is not performed.

In one aspect, at least one of the following characteristics of the anomaly associated with the detector that detected the anomaly is calculated: a hazard class of the anomaly, the type and size of the anomaly; a probability of anomaly detection by the anomaly detector; values of deviations of the predicted values of the parameters of the CPS from true values or default values, the values of the specified deviations from settings, root mean square values of the measures of deviations of at least some of the parameters of the CPS used in the anomaly detector; maximum or average values of deviations of observed values of parameters of the CPS from certain predetermined limits, durations in time and frequency of specified deviations; and detector performance in detecting anomalies.

In one aspect, the anomaly detector is selected for a particular subset of the parameters of the CPS, such that: the selected anomaly detector provides a predetermined accuracy and completeness in anomaly detection for the particular subset, in accordance with a predetermined performance of the anomaly detector on the particular subset of parameters of the CPS, or in accordance with expert knowledge about the subset of parameters of the CPS.

In one aspect, subsets of parameters of the CPS are selected in accordance with at least one of the following characteristics of the subsets: significances of the parameters of the CPS for a technological process; the parameters of the CPS being associated with a particular type of equipment; the parameters of the CPS belonging to one technological process; and based on uniformity of physical parameters of the CPS in a subset.

FIG. 7 is a block diagram illustrating a computer system 20 on which aspects of systems and methods for detecting anomalies in a cyber-physical system may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 7, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for detecting anomalies in a cyber-physical system (CPS), the method comprising:
for a list of parameters of the CPS, collecting data containing values of the parameters of the CPS;
generating at least two subsets of parameters of the CPS from the collected data;
selecting at least two anomaly detectors from a list of anomaly detectors and selecting at least one corresponding subset of the parameters of the CPS for each selected anomaly detector;
pre-processing each subset of the parameters of the CPS and transmitting an output of the pre-processing to the corresponding anomaly detector;
for each pre-processed subset, detecting anomalies in the data using the corresponding respective anomaly detector; and
detecting a combined anomaly in the CPS by combining and processing results obtained from the selected at least two anomaly detectors.

2. The method of claim 1, further comprising:
post-processing the detected anomalies from each selected anomaly detector; and
combining the post-processed detected anomalies.

3. The method of claim 1, wherein the selecting of the at least two anomaly detectors and the at least one corresponding subset of the parameters of the CPS for each selected anomaly detector is performed based on at least one of:
characteristics of the CPS;
a list of parameters of the CPS and their values from a subset of parameters of the CPS; and
types of the collected data and an amount of the collected data.

4. The method of claim 1, wherein the selecting of the at least two anomaly detectors and the at least one corresponding subset of the parameters of the CPS for each selected anomaly detector is performed based on at least one of:
a quality metric;
Receiver Operating Characteristics (ROC) curve analysis results;
execution time; and
an amount of resources used by a computer performing the anomaly detection.

5. The method of claim 1, wherein the pre-processing of a subset of the parameters of the CPS includes at least of one:
data buffering with a time buffer of a pre-determined length;
filtering of invalid data or data that was received with a delay greater than a pre-determined period of time;
reordering based on time points of obtaining the values of parameters of the CPS;
filling in gaps in the values of parameters of the CPS;
interpolation to a uniform grid;
normalization of values of the parameter of the CPS; and
repackaging the values parameters of the CPS for processing by the anomaly detector.

6. The method of claim 1, wherein a detector of the at least two anomaly detectors detects anomalies by at least one of:
detecting anomalies when a forecast error exceeds a pre-determined threshold value, wherein the forecast error is computed by predicting values of the parameters of the CPS and then determines a total forecast error for the values of the parameters of the CPS;
detecting anomalies by applying a machine learning model based on the values of the parameters of the CPS;
detecting anomalies when a rule for detecting anomalies is applied; and
detecting anomalies by comparing the values of the parameters of the CPS with limit values of ranges of values established for the respective parameters.

7. The method of claim 1, wherein a value of at least one of the parameters of the CPS comprises at least one of:
a sensor measurement;
a value of a controlled parameter of an actuator;
a setpoint of an executive mechanism;
a value of at least one input signal of a proportional-integral-differentiating (PID) regulator; and
a value of an output signal of the PID controller.

8. The method of claim 1, wherein values of the parameters of the CPS are collected from the CPS at a same time interval with an indication of the parameters of the CPS or from indication parts of the CPS in a form of a plurality of separate fluxes of values of the parameters of the CPS indicating the parameters contained in each stream.

9. The method of claim 1, wherein result obtained from the selected at least two anomaly detectors are combined in at least one of the following ways:
by combining anomaly localization regions from individual anomaly detectors such as common anomalies are localized, wherein said regions determine anomalies in space and/or time;
by analyzing contributions of each detector to the combined anomaly; and
by calculating predetermined characteristics of the combined anomaly using characteristics of the anomalies obtained from each of the detectors and information about respective contributions to the combined anomaly.

10. The method of claim 9, wherein the combining of the anomaly localization regions is performed by:
determining when a spatial or temporal region exceeds a predetermined percentage of the combined area;
determining when centers of anomaly localization regions lie in a certain spatial or temporal region; and
determining when a trained neural network identified the region as a region that belongs to a combined anomaly.

11. The method of claim 9, wherein a contribution of a particular anomaly detector to the combined anomaly is determined by setting a feature vector corresponding to the total number of anomaly detectors, and by performing at least one of the following actions:
equating the contribution of the particular anomaly to the combined anomaly to a number calculated from the contribution of the spatial or temporal region of the anomaly obtained by the particular detector to the combined anomaly;
determining the contribution of the particular anomaly by a degree of proximity to the center of the combined anomaly;
determining the contribution of the particular anomaly by applying a pretrained neural network that evaluates contributions;
when a combined anomaly of the particular detector is not present in the formation, setting the contribution to zero; and
when there is information about a degree of reliability or criticality of a particular detector for a technological process (TP) of the CPS in which the said detector detects an anomaly, changing the contribution of the detector based on the information about the degree of reliability or criticality.

12. The method of claim 9, wherein after identifying at least one anomaly by each selected anomaly detector, the output data is further post-processed, wherein the post-processing includes:
calculating an extended set of anomaly characteristics, including anomaly hazard assessment, determining types and sizes of the anomalies, normalizing and unifying the output information about anomalies, and detecting the combined anomaly by combining results obtained from the selected detectors.

13. The method of claim 9, when calculating the characteristics of the anomalies is not feasible or possible, setting a pre-determined value for the characteristics of the anomaly for which the calculation is not performed.

14. The method of claim 9, wherein at least one of the following characteristics of the anomaly associated with the detector that detected the anomaly is calculated:
a hazard class of the anomaly, the type and size of the anomaly;
a probability of anomaly detection by the anomaly detector;
values of deviations of the predicted values of the parameters of the CPS from true values or default values, the values of the specified deviations from settings, root mean square values of the measures of deviations of at least some of the parameters of the CPS used in the anomaly detector;
maximum or average values of deviations of observed values of parameters of the CPS from certain predetermined limits, durations in time and frequency of specified deviations; and
detector performance in detecting anomalies.

15. The method of claim 1, wherein, the anomaly detector is selected for a particular subset of the parameters of the CPS, such that:
the selected anomaly detector provides a predetermined accuracy and completeness in anomaly detection for the particular subset,
in accordance with a predetermined performance of the anomaly detector on the particular subset of parameters of the CPS, or
in accordance with expert knowledge about the subset of parameters of the CPS.

16. The method of claim 1, wherein subsets of parameters of the CPS are selected in accordance with at least one of the following characteristics of the subsets:
significances of the parameters of the CPS for a technological process;
the parameters of the CPS being associated with a particular type of equipment;
the parameters of the CPS belonging to one technological process; and
based on uniformity of physical parameters of the CPS in a subset.

17. A system for detecting anomalies in a cyber-physical system (CPS), comprising:
at least one processor of a computing device configured to:
collect, by a data collector, data containing values of the parameters of the CPS;
generate, by a generator, at least two subsets of parameters of the CPS from the collected data;
select, by the generator, at least two anomaly detectors from a list of anomaly detectors and selecting at least one corresponding subset of the parameters of the CPS for each selected anomaly detector;
pre-process each subset of the parameters of the CPS by respective pre-processor and transmit an output of the pre-processor to the corresponding anomaly detector;
for each pre-processed subset, detect anomalies in the data using the corresponding respective anomaly detector; and
detect, by an ensemble tool, a combined anomaly in the CPS by combining and processing results obtained from the selected at least two anomaly detectors.

18. The system of claim 17, wherein the pre-processing of a subset of the parameters of the CPS includes at least of one:
data buffering with a time buffer of a pre-determined length;
filtering of invalid data or data that was received with a delay greater than a pre-determined period of time;
reordering based on time points of obtaining the values of parameters of the CPS;
filling in gaps in the values of parameters of the CPS;
interpolation to a uniform grid;
normalization of values of the parameter of the CPS; and
repackaging the values parameters of the CPS for processing by the anomaly detector.

19. The system of claim 17, further comprising at least one post-processing unit designed to process the output of a corresponding anomaly detector before transmitting the output to the ensemble tool, each detector having a dedicated set of post-processing units.

20. The system of claim 19, wherein the post-processing units perform at least one of the following steps: assessment of risks of anomalies, determining types and sizes of anomalies, and normalizing and unification of output information about anomalies.
